(19) United States
(12) Patent Application Publication
(10) Pub. No.: US 2018/0174495 A1
(43) Pub. Date: Jun. 21, 2018

(54) TAMPER-EVIDENT BAT BARRELS

(71) Applicant: EASTON BASEBALL / SOFTBALL INC., Thousand oaks, CA (US)

(72) Inventors: Dewey CHAUVIN, Simi Valley, CA (US); Grant DOUGLAS, Santa Monica, CA (US)

(21) Appl. No.: 15/385,268

(22) Filed: Dec. 20, 2016

(51) Int. Cl. G09F 3/00; A63B 59/51; A63B 59/54

(52) U.S. Cl. CPC G09F 3/0292; A63B 59/54; A63B 59/51

(57) ABSTRACT

A ball bat includes a handle, a barrel attached to or continuous with the handle, and a tamper-evident section positioned in the barrel. The tamper-evident section may include a layer of foam material or another suitable material positioned within a wall of the barrel between an inwardly facing surface and an outer layer of the wall. The outer layer of the wall may be positioned to deform to indicate a condition of the tamper-evident section. In some embodiments, the wall is formed from a composite material. In other embodiments, the wall may include a metal alloy material and the outer layer may include a composite material. The foam material may have a compression value greater than that of a softball.

### BACKGROUND

Baseball and softball governing bodies have imposed various bat performance limits over the years with the goal of regulating batted ball speeds. Each association generally independently develops various standards and methods to achieve a desired level of play.

During repeated use of bats made from composite materials, the matrix or resin of the composite material tends to crack and the fibers tend to stretch or break. This break-in tends to reduce stiffness and increase the elasticity or trampoline effect of a bat against a ball. As a bat breaks in, it may exceed performance limitations specified by a governing body, such as limitations related to batted ball speed. Some such limitations are specifically aimed at regulating the performance of a bat that has been broken in from normal use.

Some unscrupulous players choose to intentionally break in composite bats to increase performance. Intentional break-in processes may be referred to as accelerated break-in (ABI) and may include techniques such as “rolling” a bat or otherwise compressing it, or generating hard hits to the bat with an object other than a ball. Such processes tend to be more abusive than break-in during normal use. A rolled or otherwise intentionally broken-in bat may exceed limitations established by a governing body. During play, however, it may be difficult or even impossible to determine whether a bat has been intentionally broken in, tampered with, or if it otherwise exceeds normal break-in and regulated performance limitations.

### SUMMARY

A ball bat includes a handle, a barrel attached to or continuous with the handle, and a tamper-evident section positioned in the barrel. The tamper-evident section may include a layer of foam or other suitable material positioned within a wall of the barrel between an inwardly facing surface and an outer layer of the wall. The outer layer of the wall may be positioned to deform to indicate a condition of the tamper-evident section. In some embodiments, the wall is formed from a composite material. In other embodiments, the wall may include a metal alloy material and the outer layer may include a composite material. The foam or other material may have a compression value greater than that of a softball. Other features and advantages will appear hereinafter. The features described herein may be used separately or together, or in various combinations of one or more of them.

### BRIEF DESCRIPTION OF THE DRAWINGS

In the drawings, wherein the same reference number indicates the same element throughout the views:

FIG. 1 illustrates a ball bat according to an embodiment of the present technology.

FIG. 2A illustrates a partial cross-sectional view of a straight section of a bat having a tamper-evident section according to an embodiment of the present technology.

FIG. 2B is a detailed view of the tamper-evident section shown in FIG. 2A.

FIGS. 3A and 3B illustrate partial cross-sectional views of the straight section of a bat having a tamper-evident section according to another embodiment of the present technology.

FIGS. 4A and 4B illustrate partial cross-sectional views of the straight section of a bat having a tamper-evident section according to another embodiment of the present technology.

FIGS. 5A and 5B illustrate partial cross-sectional views of the straight section of a bat having a tamper-evident section according to another embodiment of the present technology.

### DETAILED DESCRIPTION

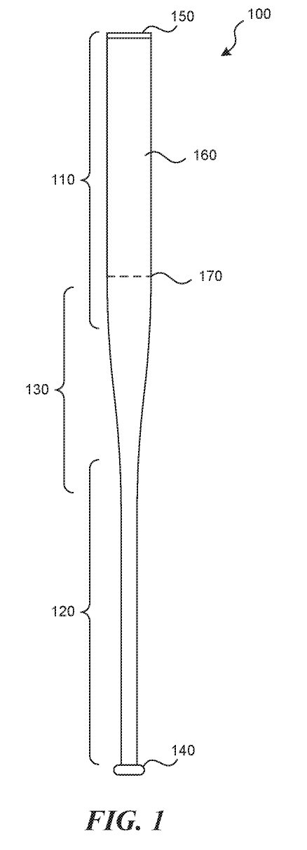

The present technology is directed to tamper-evident bat barrels, and associated systems and methods. Various embodiments of the technology will now be described. The following description provides specific details for a thorough understanding and for enabling description of these embodiments. One skilled in the art will understand, however, that the invention may be practiced without many of these details. Additionally, some well-known structures or functions may not be shown or described in detail so as to avoid unnecessarily obscuring the relevant description of the various embodiments. Accordingly, the technology may include other embodiments with additional elements or without several of the elements described below with reference to FIGS. 1-5B, which illustrate examples of the technology.

The terminology used in the description presented below is intended to be interpreted in its broadest reasonable manner, even though it is being used in conjunction with a detailed description of certain specific embodiments of the technology. Certain terms may even be emphasized below; however, any terminology intended to be interpreted in any restricted manner will be overtly and specifically defined as such in this detailed description section.

Where the context permits, singular or plural terms may also include the plural or singular term, respectively. Moreover, unless the word “or” is expressly limited to mean only a single item exclusive from the other items in a list of two or more items, then the use of “or” in such a list is to be interpreted as including (a) any single item in the list, (b) all of the items in the list, or (c) any combination of items in the list. Further, unless otherwise specified, terms such as “attached” or “connected” are intended to include integral connections, as well as connections between physically separate components.

Specific details of several embodiments of the present technology are described herein with reference to baseball or softball. The technology may also be used in other sporting good implements or in other sports or industries in which it may be desirable to indicate tampering, damage, or overuse in composites or other structures. Conventional aspects of ball bats and composite materials may be described in reduced detail herein for efficiency and to avoid obscuring the present disclosure of the technology. In various embodiments, a number of different composite materials suitable for use in ball bats may be used, including, for example, composites formed from carbon fiber, fiberglass, aramid fibers, or other composite materials or combinations of matrices, resins, fibers, laminates, and meshes forming composite materials.

Turning now to the drawings, FIG. 1 illustrates a ball bat 100 having a barrel portion 110 and a handle portion 120. There may be a transitional or taper portion 130 in which a larger diameter of the barrel portion 110 transitions to a narrower diameter of the handle portion 120. The handle portion 120 may include an end knob 140 and the barrel portion 110 may optionally be closed with an end cap 150. The barrel portion 110 may include a non-tapered or straight section 160 extending between the end cap 150 and an end area 170.

The bat 100 may have any suitable dimensions. For example, the bat 100 may have an overall length of 20 to 40 inches, or 26 to 34 inches. The overall barrel diameter may be 2.0 to 3.0 inches, or 2.25 to 2.75 inches. Typical ball bats have diameters of 2.25, 2.625, or 2.75 inches. Bats having various combinations of these overall lengths and barrel diameters, or any other suitable dimensions, are contemplated herein. The specific preferred combination of bat dimensions is generally dictated by the user of the bat 100, and may vary greatly among users.

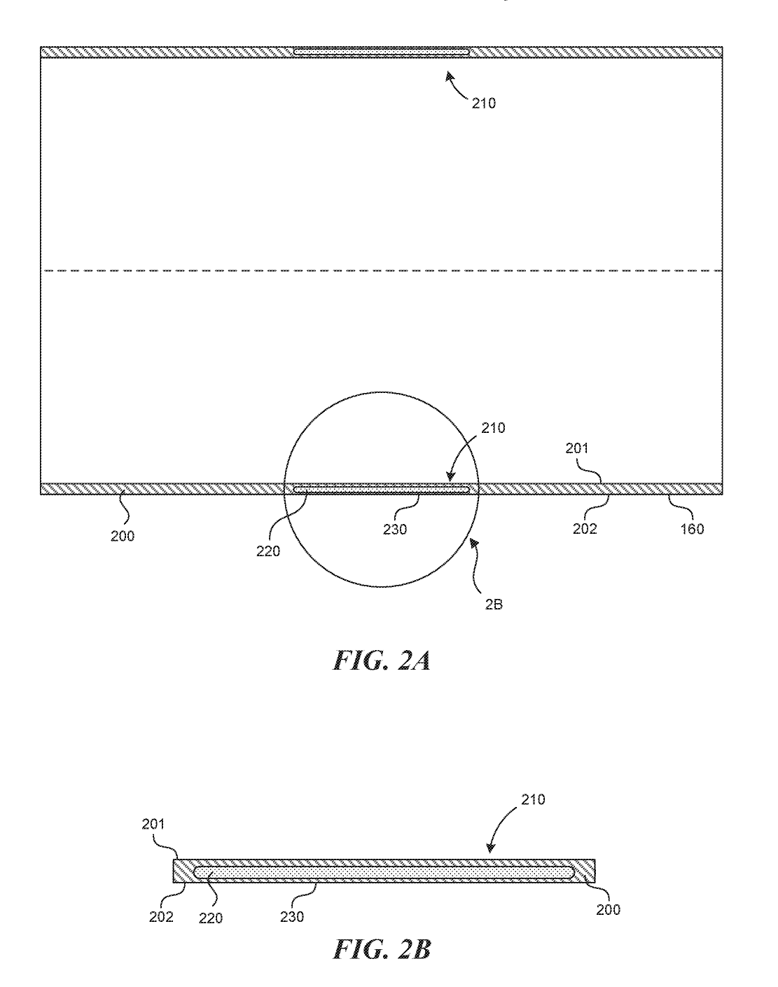

FIG. 2A illustrates a partial cross-sectional view of the straight section 160 of a bat 100 according to an embodiment of the present technology. A cylindrical composite wall 200 defines an outer structure of the bat 100, which may be hollow in some embodiments. The wall 200 may have an inwardly facing surface 201 positioned to face toward an interior area of the bat 100, and an outwardly facing surface 202 positioned to face outwardly from the bat 100. In some embodiments, the bat 100 may include interior structural elements within the composite wall 200 or elsewhere in the bat 100. The composite wall 200 may be formed from a variety of materials such as the composite materials described herein.

A tamper-evident section 210, described in further detail below, may be located somewhere along the straight section 160 of the bat 100. For example, with reference to FIG. 1, in some embodiments, the tamper-evident section 210 may be located anywhere between approximately one inch from the distal end of the bat 100 having end cap 150 and approximately one inch from the end area 170 of the straight section 160. In other embodiments, the tamper-evident section 210 may be located in other portions of the bat 100. In general, the tamper-evident section 210 may be positioned anywhere a bat may be rolled or tampered with by a user, or anywhere a regulatory body wishes to test the bat 100.

With reference to FIGS. 2A and 2B, the tamper-evident section 210 may include a layer 220 of foam material or another suitable material positioned within the composite wall 200 between outer and inner surfaces of the composite wall 200. For ease of description, this layer will be referred to as a “foam layer.” The foam layer 220 may be positioned around the entirety of the circumference of the composite wall 200 such that it forms a ring within the composite wall 200, or in some embodiments, it may not fully encircle the composite wall 200.

Balls regulated by sports associations, such as softball associations, may have specified compression values. Compression of a ball may be tested by determining the amount of force required to squeeze or compress a ball by a given amount, using ASTM F1888-09 as a testing protocol, for example. Compression relates to the hardness of a ball. Acceptable compression levels may vary. A sports organization, for example, may regulate the compression value of a softball to be 525 pounds for some levels of play, or 375 pounds for other levels of play, or 300 pounds for other levels of play. In other levels of play, a sports organization may regulate compression values to be other values.

The inventors discovered that tuning the compression values or hardness of the foam layer 220 within the composite wall 200 to be similar to, but slightly greater than, the compression value of balls used in play results in a bat 100 that more easily aids in identifying evidence of overuse, abuse, or tampering, such as rolling the bat 100. Thus, the foam layer 220 in a bat designed to be used with softball having a compression value of 525 pounds, for example, may have a compression value of approximately 50 to 400 pounds. Similarly, the foam layer 220 in a bat designed to be used with softball having a compression value of 375 pounds, for example, may have a compression value of approximately 10 to 335 pounds. In some embodiments, the compression value of the foam layer 220 is selected to be no greater than 95% of the compression value of the ball being used. One skilled in the art will understand that the compression value of the foam could be significantly lower than the compression of the ball depending upon the stiffness and durability of the shell surrounding the foam.

When the foam layer 220, or the tamper-evident section 210 as a whole, is at least slightly harder than the ball in play, during normal play the ball will deflect more than the foam layer 220 and the composite wall 200, therefore limiting damage to the section of the bat barrel having the foam layer 220. But if a bat is abused, overused, intentionally broken in, rolled, or otherwise meaningfully tampered with, an outer layer 230 of the composite wall 200 just outside of the foam layer 220 will crack or fracture. Such a crack or fracture may be evident to the naked eye of a player or official or it may be noticeable by feel.

In some embodiments, tampering may result in complete failure of the composite wall 200. Accordingly, bats using the present technology can be tuned to show evidence of deflection beyond a pre-determined limit, which aids officials and regulatory bodies in determining that a bat is no longer fit for play. In some embodiments, the tamper-evident section 210 may be used to test a sample bat from a group of produced bats 100 to pre-qualify or pre-evaluate the bat's ability to withstand routine play for a nominal amount of time. For example, a sports organization may test the bat 100 in an accelerated-use simulation to ensure that it will maintain required characteristics throughout its useful life.

The foam layer 220 may have any suitable length relative to the longitudinal length of the bat 100 or the longitudinal length of the straight section 160. For example, the foam layer 220 may be approximately 0.0625 to 0.75 inches long, or approximately one-inch long along the length of the bat. The foam layer 220 may be formed from a semi-rigid foam material such as polyurethane, polyetherimide, polyvinyl chloride (PVC), a vinyl foam, or other suitable foam materials or combinations thereof. The foam layer 220 may also have any suitable thickness in the radial direction of the bat 100, such as a thickness of approximately 0.020 to 0.75 inches.

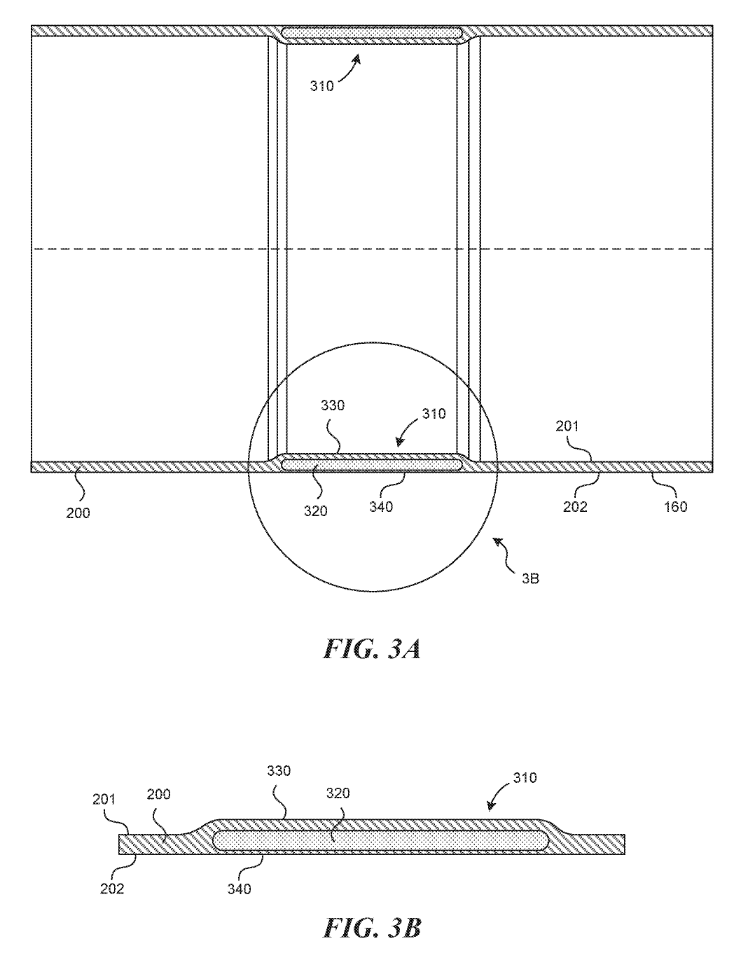

FIGS. 3A and 3B illustrate partial cross-sectional views of the straight section 160 of a bat 100 according to another embodiment of the present technology. A tamper-evident section 310 may include a layer 320 of foam material positioned within the composite wall 200 between outer and inner surfaces of the composite wall 200.

The foam layer 320 may be positioned around the entirety of the circumference of the composite wall 200 such that it forms a ring within the composite wall 200, or in some embodiments, it may not fully encircle the composite wall 200. The foam layer 320 may be made from similar materials as the foam layer 220 described above with regard to FIGS. 2A and 2B, and it may have similar properties. The foam layer 320 may be relatively thick compared to the remainder of the composite wall 200 such that the composite wall 200 may have an interior-facing stepped portion 330 projecting toward the interior of the bat 100 from the interior facing surface 201 of the composite wall 200. Accordingly, a larger foam layer 320 may be used without compromising the overall strength of the composite wall 200 in the area of the foam layer 320 or the tamper-evident section 310. If a bat is abused, overused, intentionally broken in, rolled, or otherwise tampered with, an outer layer 340 of the composite wall 200 just outside of the foam layer 320 will crack or fracture in a manner similar to the outer layer 230 described above with regard to FIGS. 2A and 2B, to provide evidence of such use or tampering.

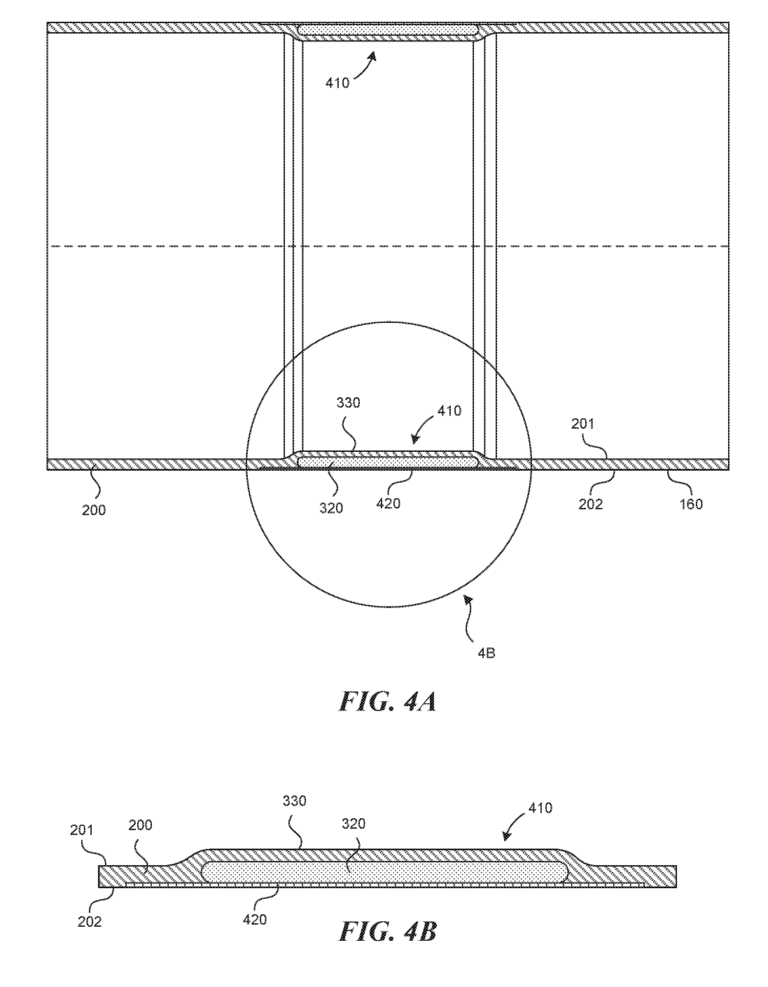

FIGS. 4A and 4B illustrate partial cross-sectional views of the straight section 160 of a bat 100 having a tamper-evident section 410 according to another embodiment of the present technology. The tamper-evident section 410 may be similar to the tamper-evident section 310 described above with regard to FIGS. 3A and 3B, except that an outer layer 420 formed from a composite or other suitable material different from the material of the composite wall 200 may cover the foam layer 320. For example, in some embodiments, the outer layer 420 may be a different composite material than the composite wall 200, or in other embodiments, it may be a metal material or alloy such as aluminum.

In some embodiments, the wall 200 itself may optionally be formed from a metal material or alloy, such as aluminum, and the wall 200 may have a circumscribed indentation or depression formed inwardly from the wall 200 and at least partially filled with the foam layer 320. The foam layer 320 positioned in the depression may be covered with a composite material, an alloy material, or another suitable material or combinations of materials to form the outer layer 420. If an alloy material is used as the outer layer 420, deformation in the form of bending or denting in the tamper-evident section 410 may indicate overuse or tampering.

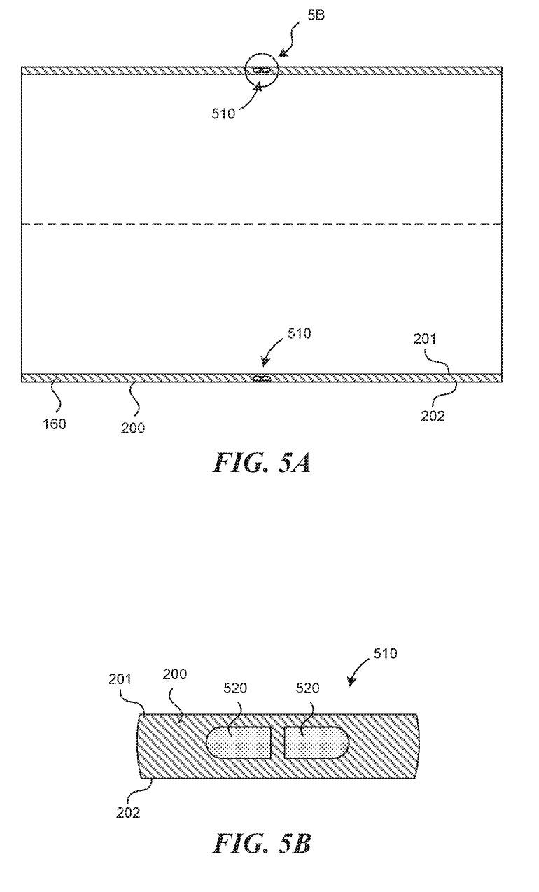

FIGS. 5A and 5B illustrate partial cross-sectional views of the straight section 160 of a bat 100 having a tamper-evident section 510 according to another embodiment of the present technology. The tamper-evident section 510 may include one or more (for example, two) D-shaped rings 520 formed from a foam material and positioned within the composite wall 200. The D-shaped foam rings 520 may be made from material similar to the foam layers described herein (for example, foam layer 220). The tamper-evident section 510 may otherwise have similar properties and functions as other tamper-evident sections disclosed herein. In other embodiments, there may be various numbers of foam rings 520 or other foam elements having various shapes and arrangements.

In various embodiments, foam layers and tamper-evident sections may be formed by including the layers in the composite layering process for making the bat 100. For example, the foam layer may be molded or laid into a standard composite wrap process, within a bladder molding, or included in a layer during a resin transfer molding process. Alternatively, bats of the present technology may be formed from a metal alloy such as aluminum, and regions of the bat wall 200 may be machined or otherwise formed to receive the foam layers and tamper-evident sections described herein.

The technology disclosed herein provides a tamper-evident section of a ball bat or a tamper-evident ball bat to facilitate determining whether a bat has been abused, overused, intentionally broken in, or otherwise tampered with. Such use or tampering may be evident by cracks or other deformation in the composite or metal materials, for example.

From the foregoing, it will be appreciated that specific embodiments of the disclosed technology have been described for purposes of illustration, but that various modifications may be made without deviating from the technology and elements of certain embodiments may be interchanged with those of other embodiments. For example, in some embodiments, a variety of materials or combinations of materials can be used as the foam layer. In some embodiments, the tamper-evident section may be positioned anywhere along the length of the bat. In some embodiments, intermediate layers of suitable materials may be positioned between foam layers and composite or aluminum portions of the bat 100. In yet further embodiments, outer surfaces of the bat 100 (including, for example, outwardly facing surface 202) may be coated with paint, vinyl, or other aesthetic or functional layers.

Further, while advantages associated with certain embodiments of the disclosed technology have been described in the context of those embodiments, other embodiments may also exhibit such advantages, and not all embodiments need necessarily exhibit such advantages to fall within the scope of the technology. Accordingly, the disclosure and associated technology may encompass other embodiments not expressly shown or described herein, and the invention is not limited except as by the appended claims.

What is claimed is:

1. A ball bat, comprising:
a handle;
a barrel attached to or continuous with the handle; and
a tamper-evident section positioned in the barrel; wherein
the tamper-evident section includes a layer of foam material positioned within a wall of the barrel between an inwardly facing surface and an outer layer of the wall; and
the outer layer of the wall is positioned to deform to indicate a condition of the tamper-evident section.

2. The ball bat of claim 1 wherein the wall is formed from a composite material.

3. The ball bat of claim 1 wherein the wall comprises a first material and the outer layer of the wall comprises a second material different from the first material.

4. The ball bat of claim 3 wherein the first material is a metal alloy and the second material is a composite material.

5. The ball bat of claim 1 wherein the wall comprises an interior-facing stepped portion projecting toward an interior region of the bat from the inwardly facing surface.

6. The ball bat of claim 1 wherein the layer of foam material comprises a plurality of separate foam elements.

7. The ball bat of claim 6 wherein at least one of the plurality of separate foam elements has a generally D-shaped cross-section.

8. The ball bat of claim 1 wherein the outer layer of the wall is configured to crack under extreme deflection to visibly indicate a condition of the tamper-evident section.

9. The ball bat of claim 1 wherein the foam material has a compression value greater than a compression value of a ball specified for use with the bat.

10. The ball bat of claim 1 wherein the foam material has a compression value greater than 300 pounds.

11. The ball bat of claim 1 wherein the tamper-evident section is positioned in a region of the barrel between approximately one inch from a distal end of the barrel and approximately one inch from an end of a straight section of the barrel proximate to the handle.

12. A ball bat, comprising:
a handle and a tamper-evident barrel attached to or continuous with the handle; wherein
the barrel includes a wall formed from a composite material; and
a layer of foam material is positioned within the wall between an inwardly facing surface and an outer layer of the wall, wherein the outer layer of the wall is configured to crack under extreme deflection to visibly indicate a condition of the tamper-evident section.

13. The ball bat of claim 12 wherein the inwardly facing surface includes an interior-facing stepped portion projecting toward an interior region of the bat from the inwardly facing surface.

14. The ball bat of claim 12 wherein the composite material is a first composite material and the outer layer of the wall is formed from a second material different from the first composite material.

15. The ball bat of claim 12 wherein the foam material has a compression value greater than a compression value of a ball specified for use with the bat.

16. The ball bat of claim 12 wherein the layer of foam material is positioned in a region of the barrel between approximately one inch from a distal end of the barrel and approximately one inch from an end of a straight section of the barrel proximate the handle.

17. A method of making a ball bat, the method comprising:
forming a handle section; and
forming a barrel section, wherein forming the barrel section includes forming a generally cylindrical wall and positioning a layer of foam material within the wall between an inwardly facing surface and an outwardly facing surface of the wall; wherein
positioning the layer of foam material includes selecting the foam material to have a compression value greater than a compression value of a ball specified for use with the bat.

18. The method of claim 17 wherein forming the generally cylindrical wall includes forming the wall with a composite material.

19. The method of claim 17 wherein forming the generally cylindrical wall includes forming the wall with a metal alloy and forming a recess in the wall positioned to receive the layer of foam material.

20. The method of claim 17 wherein positioning the layer of foam material between the inwardly facing surface and the outwardly facing surface includes forming the inwardly facing surface and the outwardly facing surface with different materials.
